(19) United States
(12) Patent Application Publication
(10) Pub. No.: US 2007/0020080 A1
(43) Pub. Date: Jan. 25, 2007

(54) Transfer devices and methods for handling microfeature workpieces within an environment of a processing machine

(76) Inventor: Paul Wirth, Columbia Falls, MT (US)

Correspondence Address: PERKINS COIE LLP, P.O. BOX 1247, PATENT-SEA, SEATTLE, WA, 98111-1247, US

(21) Appl. No.: 11/177,936

(22) Filed: Jul. 7, 2005

Related U.S. Application Data
(60) Provisional application No. 60/586,514, filed on Jul. 9, 2004.

(51) Int. Cl. B66C 23/00

(52) U.S. Cl. 414/744.5

(57) ABSTRACT

Transfer devices and methods for handling microfeature workpieces are disclosed herein. In one embodiment, a transfer device includes a transport unit configured to move along a linear track and an arm assembly carried by the transport unit. The arm assembly can include an arm pivotable about a lift path. The transfer device further includes (a) a first end-effector coupled to the arm and rotatable about an axis generally parallel to the lift path, and (b) a second end-effector coupled to the arm and rotatable about the axis. The transfer device operates normally without pneumatic power.

### CROSS-REFERENCE TO RELATED APPLICATION

This application is related to U.S. patent application Ser. No. ______ (Perkins Coie Docket No. 291958249US), entitled END-EFFECTORS FOR HANDLING MICROFEATURE WORKPIECES, filed ______, which is hereby incorporated by reference in its entirety.

### TECHNICAL FIELD

The present invention relates to equipment for handling microfeature workpieces. More particularly, the present invention is directed to transfer devices for handling microfeature workpieces within an environment of a processing machine.

### BACKGROUND

Microelectronic devices are fabricated on and/or in microelectronic workpieces using several different apparatus (“tools”). Many such processing apparatus have a single processing station that performs one or more procedures on the workpieces. Other processing apparatus have a plurality of processing stations that perform a series of different procedures on individual workpieces or batches of workpieces. The workpieces are often handled by automatic handling equipment (i.e., robots) because microelectronic fabrication requires very precise positioning of the workpieces and/or conditions that are not suitable for human access (e.g., vacuum environments, high temperatures, chemicals, stringent clean standards, etc.).

An increasingly important category of processing apparatus is plating tools that plate metals and other materials onto workpieces. Existing plating tools use automatic handling equipment to handle the workpieces because the position, movement, and cleanliness of the workpieces are important parameters for accurately plating materials onto the workpieces. The plating tools can be used to plate metals and other materials (e.g., ceramics or polymers) in the formation of contacts, interconnects, and other components of microelectronic devices. For example, copper plating tools are used to form copper contacts and interconnects on semiconductor wafers, field emission displays, read/write heads, and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched and/or annealed in subsequent procedures before transferring the workpiece to another apparatus.

Single-wafer plating tools generally have a load/unload station, a number of plating chambers, a number of cleaning chambers, and a transfer mechanism for moving the workpieces between the various chambers and the load/unload station. The transfer mechanism can be a rotary system having one or more robots that rotate about a fixed location in the plating tool. One existing rotary transfer mechanism is shown in U.S. Pat. No. 6,136,163 issued to Cheung, et al. Alternate transfer mechanisms include linear systems that have an elongated track and a plurality of individual robots that can move independently along the track. Each of the robots on a linear track can also include independently operable end-effectors. Existing linear track systems are shown in: (a) U.S. Pat. Nos. 5,571,325; 6,318,951; 6,322,119; 6,749,390; and 6,752,584; (b) PCT Publication No. WO 00/02808; and (c) U.S. Publication No. 2003/0159921, all of which are herein incorporated in their entirety by reference. Many rotary and linear transfer mechanisms have a plurality of individual robots that can each independently access most, if not all, of the processing stations within an individual tool to increase the flexibility and throughput of the plating tool.

These robots use end-effectors to carry the workpieces from one processing station to another. The end-effectors are typically coupled to one or more arms that project laterally from the robot. For example, one conventional robot includes an arm with a first extension for supporting a first end-effector and a second extension for supporting a second end-effector. The first and second extensions project in opposite directions in a plane generally parallel to the track.

One concern with such robots is that the processing stations must be spaced a sufficient distance from the track so that the arm extensions do not contact the stations when the robot rotates. The increased spacing between the processing stations on opposite sides of the track increases the footprint of the tool. To address this concern, some robots are designed to pivot but not completely rotate so that the arm extensions do not contact the processing stations. Because these robots cannot rotate, they must move linearly along the track to perform certain tasks. For example, after picking up a first workpiece from a processing station with the first end-effector, the robot must move along the track in order to place a second workpiece at the same processing station with the second end-effector. The need to translate along the track increases the time required for the robot to perform certain tasks, which reduces the throughput of the tool. Accordingly, there is a need to improve transfer devices to increase the throughput and decrease the footprint of the tool.

The nature and design of conventional end-effectors depends, in part, on the nature of the workpiece being handled. For example, when the backside of the workpiece may directly contact the end-effector, a vacuum end-effector may be used. Such vacuum end-effectors typically have a plurality of vacuum outlets that draw the backside of the workpiece against a paddle or other type of end-effector. In other circumstances, however, the workpieces have components or materials on both the backside and the device side that cannot be contacted by the end-effector. For example, workpieces that have wafer-level packaging have components on both the device side and the backside. Such workpieces typically must be handled by edge-grip end-effectors, which contact the edge of the workpiece and only a small perimeter portion of the device side and/or backside of the workpiece.

Several current edge-grip end-effectors use an active member that moves in the plane of the workpiece between a release position and a processing position to retain the workpiece on the end-effector. In the release position, the active member is disengaged from the workpiece and spaced apart from the workpiece to allow loading/unloading of the end-effector. In the processing position, the active member presses against the edge of the workpiece to drive the workpiece laterally against other edge-grip members in a manner that secures the workpiece to the end-effector. The active member can be a plunger with a groove that receives the edge of the workpiece, and the other edge-grip members can be projections that also have a groove to receive other portions of the edge of the workpiece. In operation, a pneumatic or hydraulic motor moves the active member radially outward to the release position for receiving a workpiece and then radially inward to the processing position for securely gripping the edge of the workpiece in the grooves of the edge-grip members and the active member.

One concern with both vacuum end-effectors and active edge-grip end-effectors is that they have moving components, which are complex and expensive to manufacture and service. For example, these end-effectors include rotary couplings for passing the air and/or hydraulic fluid from the base of the robot to the end-effector. Pneumatic and hydraulic rotary couplings are expensive and require extensive maintenance to prevent leaking and failure. In addition to maintenance expenses, significant downtime may be required to replace or repair the rotary couplings.

Another concern of active edge-grip end-effectors is that the pneumatic or hydraulic motor is difficult to precisely control. More specifically, the pneumatic or hydraulic motor may drive the active member toward the workpiece with inadequate force such that the active member does not properly engage the workpiece or excessive force such that active member strikes the workpiece too hard and damages the workpiece. Accordingly, there is a need to improve end-effectors to increase control and reduce the number of complex and expensive components.

Still another concern of edge-grip end-effectors is accurately determining when a workpiece is securely held in place. Many existing systems use an optical or mechanical flag that provides a signal corresponding to the position of the active member. Although this method is generally suitable, it may give a false positive indication that a workpiece is secured to the end-effector. For example, a workpiece may be askew on the end-effector such that the active member does not engage the workpiece, but a flag system will still indicate that the workpiece is in place if the active member moves to the deployed position. Some systems over extend the active member to avoid this, but the active member may stick and not move to such an over-deployed position. Thus, there is also a need to provide a more accurate indication of workpiece status on the end-effector.

### SUMMARY

The present invention is directed toward transfer devices having coaxial end-effectors and electrical components that do not require pneumatic and/or hydraulic power. The transfer devices include a first end-effector pivotable about an axis and a second end-effector pivotable about the same axis. Consequently, the first end-effector can pick up a first workpiece from a processing station and the second end-effector can place a second workpiece on the processing station without the base of the device moving along the track. Because the base of the transfer device does not need to move while performing certain tasks, the device can perform these tasks more quickly. Thus, the transfer device increases the throughput of the tool. Another aspect of the device is that the arm projects in a single direction from only a single side of the base of the transfer device to carry the coaxial end-effectors. As such, the spacing between processing stations on opposite sides of the track can be reduced, which reduces the footprint of the tool.

The transfer devices include a transport unit configured to move along a linear track and an arm assembly carried by the transport unit. The arm assembly has an arm pivotable about a first axis. The transfer devices further include (a) a first end-effector coupled to the arm and rotatable about a second axis generally parallel to the first axis, and (b) a second end-effector coupled to the arm and coaxially rotatable about the second axis. The transfer devices can be all-electric components that operate normally without pneumatic power.

The end-effectors can include an active retaining assembly and an electrical motor or other driver for moving the retaining assembly between a retracted position in which a workpiece is loaded/unloaded and an engagement position in which the workpiece is grasped. Because the end-effectors do not use pneumatic and/or hydraulic power during normal operation, the end-effectors do not have expensive rotary pneumatic couplings and/or rotary hydraulic couplings that may be subject to leaking and failure. The end-effectors accordingly reduce maintenance expenses, reduce system downtime, and increase throughput. Furthermore, the electrical motor or driver provides better control in moving the active retaining assembly to engage a workpiece and sensing whether a workpiece is loaded properly on the end-effector. As such, the end-effectors are expected to properly engage workpieces without striking the workpieces with excessive force.

### BRIEF DESCRIPTION OF THE DRAWINGS

FIG. 1 is an isometric view of an apparatus for processing microfeature workpieces including a transfer device for handling the workpieces in accordance with an embodiment of the invention. A portion of the processing apparatus is shown in a cut-away illustration.

FIG. 2 is an isometric view of a transfer device for handling microfeature workpieces in accordance with one embodiment of the invention.

FIG. 3 is a side view of the transfer device of FIG. 2.

FIG. 4 is a schematic side cross-sectional view of an arm of a robot unit in accordance with one embodiment of the invention.

FIG. 5 is an exploded view of the arm of FIG. 4.

FIG. 6 is an enlarged schematic side cross-sectional view of a distal end of an arm and a proximal portion of first and second end-effectors in accordance with one embodiment of the invention.

FIG. 7 is an isometric view illustrating one embodiment of an end-effector for use on a transfer device.

FIG. 8 is an isometric view of the end-effector of FIG. 7 with a workpiece.

FIG. 9 is a top plan view of a portion of the end-effector of FIG. 7 with a cover removed.

FIG. 10 is a schematic isometric view of a detector in the end-effector for determining the position of an active retaining assembly.

FIG. 11 is a top plan view of a modular tool unit illustrating one environment in which the transfer devices can be used.

### DETAILED DESCRIPTION

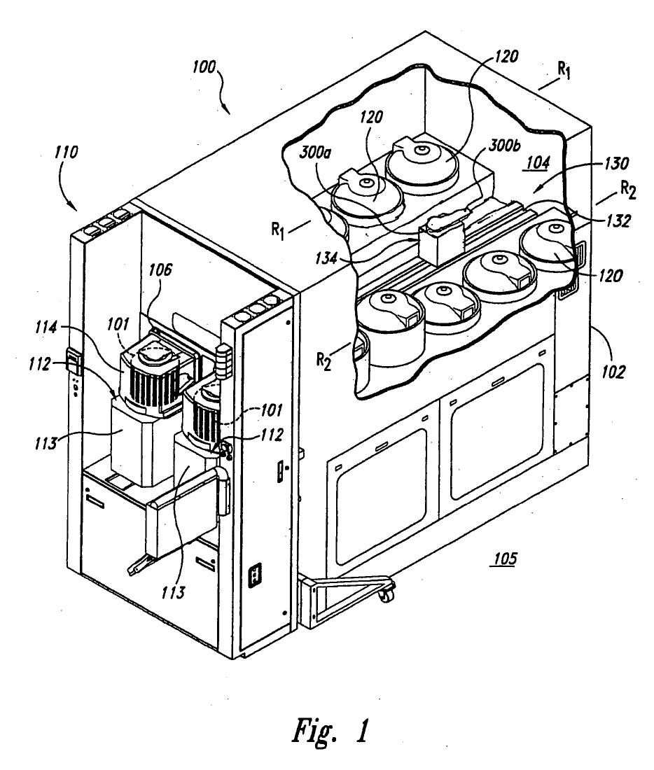

The following description discloses the details and features of several embodiments of transfer devices with end-effectors for handling microfeature workpieces and methods for using such devices. The terms “microfeature workpiece” or “workpiece” refer to substrates on and/or in which microdevices are formed. Typical microdevices include microelectronic circuits or components, thin-film recording heads, data storage elements, microfluidic devices, and other products. Micromachines or micromechanical devices are included within this definition because they are manufactured in much the same manner as integrated circuits. The substrates can be semiconductive pieces (e.g., silicon wafers or gallium arsenide wafers), nonconductive pieces (e.g., various ceramic substrates), or conductive pieces (e.g., doped wafers). It will be appreciated that several of the details set forth below are provided to describe the following embodiments in a manner sufficient to enable a person skilled in the art to make and use the disclosed embodiments. Several of the details and advantages described below, however, may not be necessary to practice certain embodiments of the invention. Additionally, the invention can also include additional embodiments that are within the scope of the claims, but are not described in detail with respect to FIGS. 1-11.

The operation and features of transfer devices with end-effectors for handling microfeature workpieces are best understood in light of the environment and equipment in which they can be used. As such, the following description is divided into the following sections: (A) Embodiments of Microfeature Workpiece Processing Machines for Use with Automatic Workpiece Transfer Devices; (B) Embodiments of Transfer Devices for Handling Microfeature Workpieces in Processing Machines; (C) Embodiments of End-effectors for Handling Microfeature Workpieces; and (D) Embodiments of Modular Tool Units Including Transfer Devices.

A. Embodiments of Microfeature Workpiece Processing Machines for Use with Automatic Workpiece Transfer Devices

FIG. 1 is an isometric view of a processing apparatus 100 having a transfer device 130 for manipulating a plurality of microfeature workpieces 101 in accordance with an embodiment of the invention. A portion of the processing apparatus 100 is shown in a cut-away view to illustrate selected internal components. The processing apparatus 100 can include a cabinet 102 having an interior region 104 defining an enclosure that is at least partially isolated from an exterior region 105. The illustrated cabinet 102 also includes a plurality of apertures 106 through which the workpieces 101 can ingress and egress between the interior region 104 and a load/unload station 110.

The load/unload station 110 can have two container supports 112 that are each housed in a protective shroud 113. The container supports 112 are configured to position workpiece containers 114 relative to the apertures 106 in the cabinet 102. The workpiece containers 114 can each house a plurality of microfeature workpieces 101 in a “mini” clean environment for carrying a plurality of workpieces through other environments that are not at clean room standards. Each of the workpiece containers 114 is accessible from the interior region 104 of the cabinet 102 through the apertures 106.

The processing apparatus 100 further includes a plurality of processing stations 120 and the transfer device 130 in the interior region 104 of the cabinet 102. The processing apparatus 100, for example, can be a plating tool, and the processing stations 120 can be single-wafer chambers for electroplating, electroless plating, annealing, cleaning, etching, and/or metrology analysis. Suitable processing stations 120 for use in the processing apparatus 100 are disclosed in U.S. Pat. Nos. 6,660,137; 6,569,297; 6,471,913; 6,309,524; 6,309,520; 6,303,010; 6,280,583; 6,228,232; and 6,080,691, and in U.S. patent application Ser. Nos. 10/861,899; 10/729,349; and 09/733,608, all of which are herein incorporated in their entirety by reference. The processing stations 120 are not limited to plating devices, and thus the processing apparatus 100 can be another type of tool.

The transfer device 130 moves the microfeature workpieces 101 between the workpiece containers 114 and the processing stations 120. For example, the transfer device 130 can include a linear track 132 extending in a lengthwise direction between the processing stations 120. In the embodiment shown in FIG. 1, a first set of processing stations 120 is arranged along a first row R₁-R₁ and a second set of processing stations 120 is arranged along a second row R₂-R₂. The linear track 132 extends between the first and second rows R₁-R₁ and R₂-R₂ of the processing stations 120. The transfer device 130 can further include a robot unit 134 carried by the track 132.

B. Embodiments of Transfer Devices for Handling Microfeature Workpieces in Processing Machines

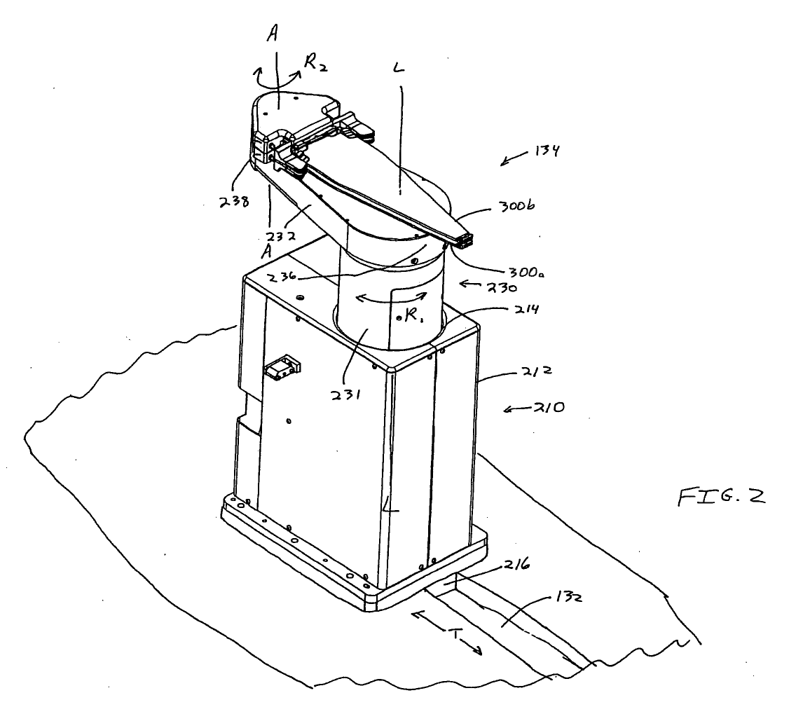

FIG. 2 is an isometric view of an embodiment of the robot unit 134 in greater detail. The illustrated robot unit 134 includes a transport unit 210, an arm assembly 230 carried by the transport unit 210, and first and second end-effectors 300 (identified individually as 300a and 300b) carried by the arm assembly 230. The transport unit 210 can include a shroud or housing 212 having a plurality of panels attached to an internal frame (not shown). A top panel of the housing 212 includes an opening 214 for receiving a portion of the arm assembly 230. It will be appreciated that the transport unit 210 and the housing 212 can have many different configurations depending upon the particular environment in which the robot unit 134 is used. The transport unit 210, for example, can include a base that is stationary, rotary, or moves in a nonlinear manner. The transport unit 210 can also include a guide member configured to move laterally along the track 132. The particular embodiment of the transport unit 210 shown in FIG. 2 includes a guide member defined by a base plate 216 that slidably couples the robot unit 134 to the track 132. The robot unit 134 can accordingly translate along the track 132 (arrow T) to position the robot unit 134 adjacent to a desired processing station 120 (FIG. 1).

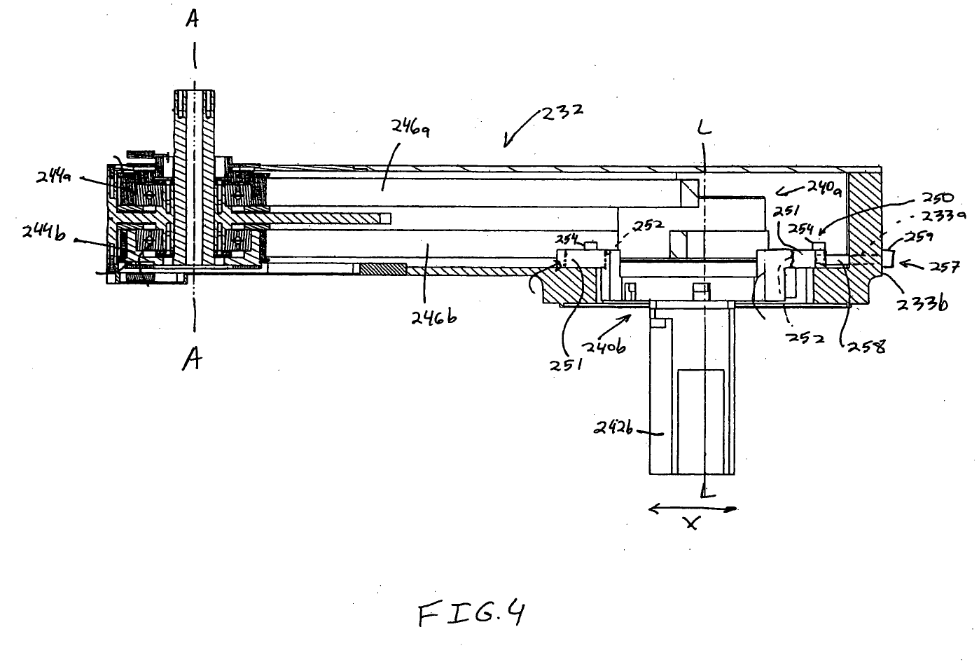

The arm assembly 230 can include a waist member 231 coupled to a lift assembly (not shown) and an arm 232 projecting from the waist member 231. The arm 232 includes a proximal end 236 attached to the waist member 231, a distal end 238 opposite the proximal end 236, and a plurality of drive assemblies (shown in FIGS. 4-6) for driving the end-effectors 300 as described below in greater detail. The arm 232 has a fixed length and is fixedly attached to the waist member 231 so that it rotates with the waist member 231. As such, the arm 232 defines a single-link arm to which the end-effectors 300 can be attached directly without intervening links pivotably attached between the arm 232 and the end-effectors 300. The arm assembly 230 can move along a lift path L-L to change the elevation of the arm 232 for positioning the end-effectors 300 at desired elevations. The lift path L-L extends generally transverse to the track 132. The arm assembly 230 can also rotate (arrow R₁) about the lift path L-L to position the distal end 238 of the arm 232 proximate to a desired workpiece container 114 (FIG. 1) or processing station 120 (FIG. 1). In other embodiments, the arm assembly 230 may be at a fixed elevation.

The end-effectors 300 are rotatably coupled to the distal end 238 of the arm 232 to rotate about an axis A-A (arrow R₂). The rotation axis A-A can be generally parallel to the lift path L-L, but in alternate embodiments this axis can be transverse to the lift path L-L. The rotational motion of (a) the arm 232 about the lift path L-L, (b) the first end-effector 300a about the rotation axis A-A, and (c) the second end-effector 300b about the rotation axis A-A can be coordinated so that the first and second end-effectors 300a-b can be positioned in the workpiece containers 114 (FIG. 1) or processing stations 120 (FIG. 1).

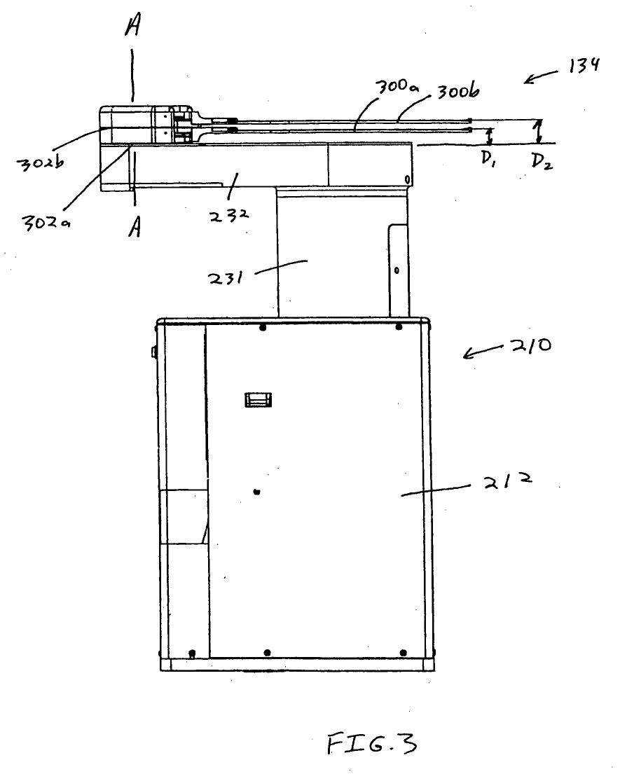

FIG. 3 is a side view of the robot unit 134 of FIG. 2. The first end-effector 300a can be spaced apart from the arm 232 by a first distance D₁, and the second end-effector 300b can be spaced apart from the arm 232 by a second distance D₂ greater than the first distance D₁ such that the first end-effector 300a is at a different elevation than the second end-effector 300b. The first end-effector 300a accordingly moves through a first plane as it rotates about the rotation axis A-A, and the second end-effector 300b moves through a second plane as it rotates about the rotation axis A-A. The first and second planes are generally parallel and fixedly spaced apart from each other so that the first and second end-effectors 300a-b cannot interfere with one another. In several embodiments, however, the first and second planes can be arranged differently (i.e., nonparallel). The first and second end-effectors 300a-b can be fixed at the particular elevations relative to the arm 232 using spacers or other types of devices. For example, the first end-effector 300a can be spaced apart from the arm 232 by a first spacer 302a, and the second end-effector 300b can be spaced apart from the first end-effector 300a by a second spacer 302b.

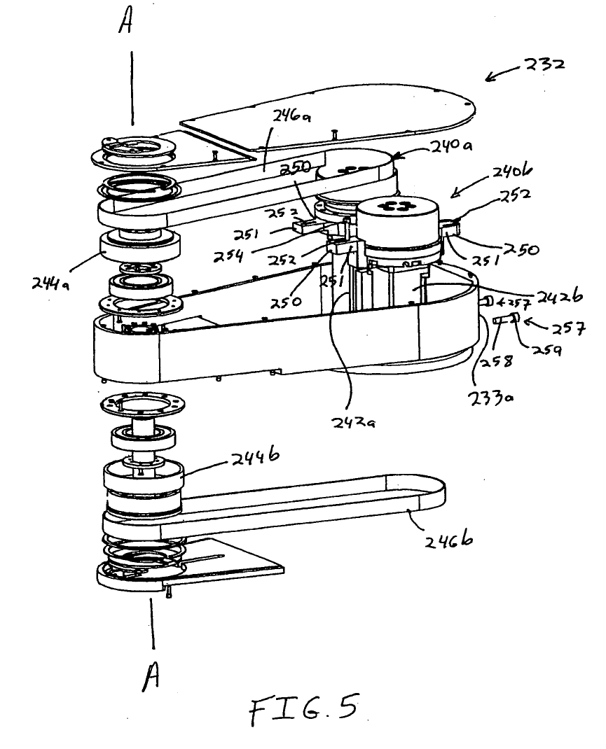

FIG. 4 is a schematic side cross-sectional view and FIG. 5 is an exploded view of the arm 232 in accordance with one embodiment of the invention. Referring to both FIGS. 4 and 5, the arm 232 includes a first drive assembly 240a for rotating the first end-effector 300a (FIG. 2) about the axis A-A and a second drive assembly 240b for rotating the second end-effector 300b (FIG. 2) about the axis A-A. The illustrated first drive assembly 240a includes a first motor 242a (FIG. 5), a first pulley 244a, and a first belt 246a for transmitting motion from the first motor 242a to the first pulley 244a. The illustrated second drive assembly 240b includes a second motor 242b, a second pulley 244b, and a second belt 246b for transmitting motion from the second motor 242b to the second pulley 244b. The first and second pulleys 244a-b are operably coupled to the first and second end-effectors 300a-b, respectively, as described in detail below. The first and second drive assemblies 240a-b are independently operable so that the first and second end-effectors 300a-b can move about the axis A-A independently from each other. The individual first and second drive assemblies 240a-b can also include a mounting plate 250 for coupling the motors 242 to the arm 243. The illustrated mounting plates 250 include two flanges 251 with slots 252. A plurality of seating bolts 254 are received in corresponding slots 252 to attach the mounting plate 250 to the arm 232.

The individual drive assemblies 240 can further include a tensioning mechanism for adjusting the tension in the corresponding belts 246. In the illustrated embodiment, the individual tensioning mechanisms include an adjustment bolt 257 that engages a corresponding mounting plate 250 and moves the plate 250 and the respective motor 242 relative to the arm 232 for adjusting the tension in the belts 246. More specifically, the adjustment bolts 257 include a threaded portion 258 and a head 259, and the outside flanges 251 include a threaded aperture (not shown) configured to engage the threaded portion 258 of the bolts 257. A portion of the bolts 257 also extends through a hole 233a in a wall 233b of the arm 232. The head 259 is positioned outside the wall 233 so that rotation of the adjustment bolts 257 moves the corresponding mounting plates 250 and motors 242 in a direction transverse to the axis A-A to change the tension in the respective belt 246. Depending upon the direction of rotation, the adjustment bolts 257 increase or decrease the tension in the belts 246. As the mounting plate 250 moves, the seating bolts 254 slide through the corresponding slots 251, which define the range of motion.

One feature of the arm 232 illustrated in FIGS. 4 and 5 is that the tensioning mechanisms adjust the tension in the belts 246 by moving the motors 242 relative to the corresponding pulleys 244. An advantage of this feature is that the belts 246 have a longer life because they are not subject to asymmetrical loading that creates uneven wear. By contrast, in conventional drive systems, the position of the motor is fixed relative to the pulley and the tension in the belt is adjusted by pressing a roller against one side of the belt, which creates uneven wear in the belt.

FIG. 6 is an enlarged schematic side cross-sectional view of the distal end 238 of the arm 232 and a proximal portion of the end-effectors 300. The first drive assembly 240a further includes an annular bearing 260a and a clamp 261 attached to the bearing 260a. The bearing 260a is positioned between the first pulley 244a and an interior member 235 of the arm 232 so that the pulley 244a can rotate about the axis A-A. The bearing clamp 261 is attached to the interior member 235 to secure a stationary portion of the bearing 260a to the arm 232. The first pulley 244a is attached to the rotating portion of the bearing 260a and to the first end-effector 300a so that the first end-effector 300a pivots about the axis A-A as the first belt 246a (FIG. 4) drives the first pulley 244a.

The second drive assembly 240b further includes an annular bearing 260b, a clamp 262 attached to a fixed portion of the bearing 260b, and a drive shaft 275 for connecting the second pulley 244b to the second end-effector 300b. The drive shaft 275 has a first portion 276a attached to the second pulley 244b and the rotating portion of the bearing 260b. The drive shaft 275 also has a second portion 276b attached to the second end-effector 300b. The second portion 276b is a cylindrical member that extends through an aperture 237 in the interior member 235, an aperture 245 in the first pulley 244a, and an aperture 281 in the first end-effector 300a. In operation, the second belt 246b (FIG. 4) drives the second pulley 244b about the fixed portion of the bearing 260b to rotate the second end-effector 300b about the axis A-A.

The first and second drive assemblies 240a-b can also include a quick-release mechanism for removing the first and second belts 246a-b from the first and second pulleys 244a-b, respectively. For example, the illustrated first drive assembly 240a includes a removable flange 263a, a snap ring 267a, and a fixed flange 269a. The snap ring 267a holds the removable flange 263a against one side of the first pulley 244a and the fixed flange 269a is fixed relative to an opposing side of the first pulley 244a to inhibit the first belt 246a (FIG. 4) from slipping off the first pulley 244a. The removable flange 263a, more specifically, can be an annular member with a recess 265 for receiving the snap ring 267a.

To remove the first belt 246a from the first pulley 244a, the snap ring 267a is moved (expanded) from a first position (illustrated in FIG. 6) in which the ring 267a holds the removable flange 263a against the first pulley 244a to a second position in which the ring 267a, the flange 263a, and the first belt 246a can slide off the first pulley 244a. In the first position, the snap ring 267a is received in the recess 265 of the flange 263a and partially in a groove 247a in the first pulley 244a. Because the snap ring 267a is partially received in the groove 247a, the ring 267a holds the removable flange 263a against the first pulley 244a. After removing the first and second end-effectors 300a-b and a removable plate 239a of the arm 232, an operator can remove the first belt 246a from the first pulley 244a by moving the snap ring 267a to the second position. More specifically, the operator exerts a radially outward force on the snap ring 267a to slide the ring 267a out of the groove 247a and completely into the recess 265 so that the snap ring 267a, the flange 263a, and the first belt 246a can slide off the first pulley 244a.

The second drive assembly 240b also includes a removable flange 263b, a snap ring 267b, and a fixed flange 269b. The snap ring 267b holds the removable flange 263b against one side of the second pulley 244b, and the fixed flange 269b is fixed relative to an opposing side of the second pulley 244b to inhibit the second belt 246b (FIG. 4) from sliding off the second pulley 244b. The snap ring 267b is movable between a first position (illustrated in FIG. 6) in which the ring 267b holds the flange 263b against the second pulley 244b and a second position in which the ring 267b, the flange 263b, and the second belt 246b can slide off the second pulley 244b. In the first position, the snap ring 267b is partially received in a groove 247b in the first portion 276a of the drive shaft 275. Because the snap ring 267b is partially received in the groove 247b, the ring 267b holds the flange 263b against the second pulley 244b. After removing a plate 239b from the arm 232, an operator can remove the second belt 246b from the second pulley 242b by moving the snap ring 267b to the second position. More specifically, the operator exerts a radially outward force on the snap ring 267b to slide the ring 267b out of the groove 247b so that the snap ring 267b, the flange 263b, and the second belt 246b can slide off the second pulley 244b. In other embodiments, the quick release mechanisms and/or the first and second drive assemblies 240a-b can have other configurations.

One feature of the illustrated arm 232 is that the first and second drive assemblies 240a-b include quick-release mechanisms for removing the first and second belts 246a-b from the first and second pulleys 244a-b, respectively. An advantage of this feature is that the belts 246 can be removed from the pulleys 244 for repair or inspection without detaching the pulleys 244 from the arm 232. By contrast, in conventional arms, removing the belts requires detaching the pulleys from the arm. As such, the arm 232 illustrated in FIG. 6 (a) reduces the downtime for maintenance and repair of the belts 246, (b) reduces the associated maintenance expenses, and (c) increases throughput of the tool.

The illustrated arm 232 further includes first and second rotary electrical couplings 270 and 271 for transmitting electrical power through the arm 232 to the end-effectors 300. The first rotary electrical coupling 270 includes (a) a first contact 270a attached to the first end-effector 300a, and (b) a first slip ring 270b attached to the removable plate 239a and electrically coupled to a power source. The first contact 270a and the first slip ring 270b are positioned so that the first slip ring 270b provides electrical power to the first contact 270a as the first end-effector 300a pivots about the axis A-A. The second rotary electrical coupling 271 includes (a) a second contact 271a attached to the removable plate 239b and electrically coupled to a power source, and (b) a second slip ring 271b attached to the first portion 276b of the drive shaft 275 and electrically coupled to the second end-effector 300b. The second contact 271a and the second slip ring 271b are positioned so that the second contact 271a can provide electrical power to the second slip ring 271b as the drive shaft 275 and second end-effector 300b pivot about the axis A-A. As described in detail below, the illustrated arm 232 and end-effectors 300 do not include rotary pneumatic or hydraulic couplings.

C. Embodiments of End-Effectors for Handling Microfeature Workpieces

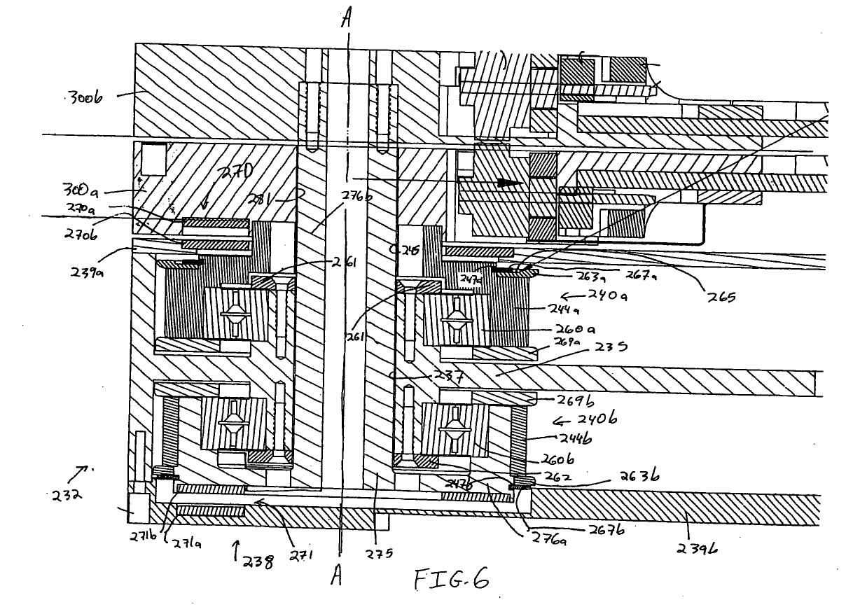

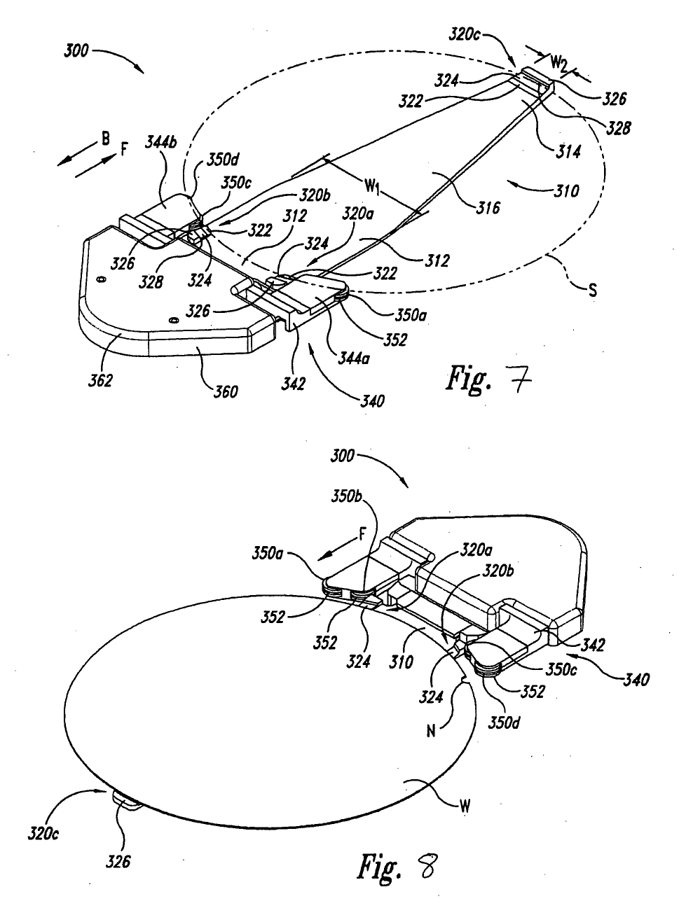

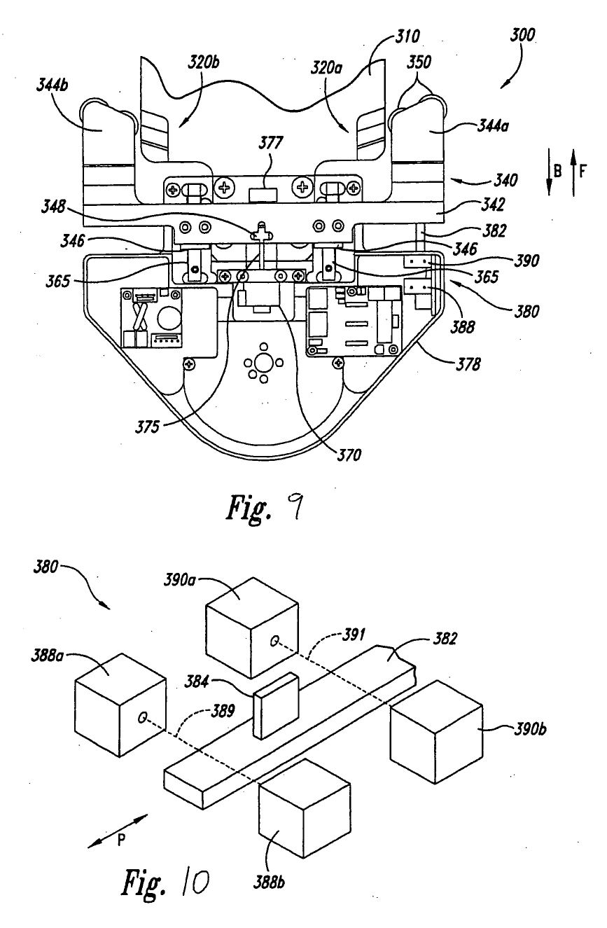

FIG. 7 is an isometric view illustrating an embodiment of one of the end-effectors 300. The illustrated end-effector 300 includes a body 310, a plurality of passive retaining elements 320 (identified individually as 320a-c) on the body 310, and an active retaining assembly 340 movable relative to the body 310. The body 310 supports a microfeature workpiece, and the passive retaining elements 320 and the active retaining assembly 340 work together to secure the workpiece to the body 310 while the robot unit 134 (FIG. 2) moves the workpiece. As such, the passive retaining elements 320 and the active retaining assembly 340 prevent the end-effector 300 from dropping the workpiece during transport.

The body 310 is typically a planar member having a fork, paddle, or other suitable configuration for carrying the workpiece. The illustrated body 310 includes a proximal portion 312 having a first width W₁, a distal portion 314 having a second width W₂ less than the first width W₁, and an intermediate portion 316 between the proximal and distal portions 312 and 314. The intermediate portion 316 can be a solid section without apertures, or alternatively, the intermediate portion 316 can have holes or slots to mitigate backside contamination of the workpiece. The body 310 is made of a stiff material that is dimensionally stable so that the robot unit 134 (FIG. 2) can accurately pick up and place workpieces. The material may also be relatively lightweight to (a) reduce the force required for the robot unit 134 to move the end-effector 300 and (b) allow the robot unit 134 to move the end-effector 300 more quickly. Suitable materials include carbon-fiber and vespel materials manufactured by DuPont. In several embodiments, the body 310 can be made of different materials and/or have other configurations.

The passive retaining elements 320 are arranged on the body 310 along a circle S corresponding to a diameter of the workpiece. In the illustrated embodiment, first and second passive retaining elements 320a-b are attached at the proximal portion 312 of the body 310, and a third passive retaining element 320c is attached at the distal portion 314 of the body 310. The three-point element configuration of the end-effector 300 shown in FIG. 7 provides a base for supporting the workpiece during transport. It will be appreciated that the body 310 can have a different number and/or arrangement of passive retaining elements 320 in other applications.

The passive retaining elements 320a-c have generally similar structures for supporting the workpiece. More specifically, the passive retaining elements 320a-c include a support surface 324 for carrying a perimeter portion of the workpiece and an edge stop 326 projecting upwardly from the support surface 324. The edge stops 326 circumscribe a circle that has a diameter slightly greater than the diameter of the workpiece to limit lateral movement of the workpiece within the circle S. The edge stops 326 can have a contact surface 328 for pressing radially inwardly against a perimeter edge of the workpiece. At least a portion of the contact surface 328 of the passive retaining elements 320 can slope upwardly inwardly toward the workpiece to inhibit the workpiece from moving upwardly and over the retaining elements 320. The passive retaining elements 320a-c can also have an inclined surface 322 sloping downwardly from the support surface 324. The passive retaining elements 320a-c can accordingly support an outer edge of the workpiece such that the workpiece is held in a plane spaced apart from the body 310 to minimize contamination of the workpiece. It will be appreciated that the passive retaining elements 320 can have other configurations for supporting the workpiece.

The illustrated active retaining assembly 340 includes a yoke 342 and a plurality of rollers 350 (identified individually as 350a-d) coupled to the yoke 342. The yoke 342 includes a first end portion 344a carrying first and second rollers 350a-b and a second end portion 344b carrying third and fourth rollers 350c-d. The rollers 350 can include a groove 352 for selectively engaging a perimeter edge of the workpiece. The active retaining assembly 340 is movable between a retracted position for loading/unloading a workpiece and an engagement position for grasping the workpiece. More specifically, the active retaining assembly 340 moves in a direction F from the retracted position to the engagement position in which the rollers 350 engage the perimeter edge of the workpiece. When the active retaining assembly 340 is in the engagement position, the end-effector 300 securely holds the workpiece between the rollers 350 and the third passive retaining element 320c. To unload the workpiece, the active retaining assembly 340 moves in a direction B from the engagement position to the retracted position in which the rollers 350 are disengaged from the workpiece. In several embodiments, the active retaining assembly 340 can include a different number of rollers 350, or alternatively, a different type of active retaining member(s) coupled to the yoke 342 in addition to or in lieu of the rollers 350.

FIG. 8 is an isometric view of the end-effector 300 with a workpiece W for illustrating one purpose of the rollers 350 in greater detail. As the active retaining assembly 340 moves in the direction F to engage the perimeter edge of the workpiece W, the rollers 350 center the workpiece W as it is clamped between the third passive retaining element 320c and the rollers 350. For example, if the workpiece W is skewed relative to the body 310, the workpiece W will move along the rollers 350 as the yoke 342 moves in the direction F. The rotation of the rollers 350 accordingly centers the workpiece W relative to the body 310. Moreover, by having two rollers 350 in a stepped or angled arrangement on each side of the yoke 342, the rollers 350 cause the workpiece W to move relative to the body 310 even when an alignment notch N is positioned at one of the rollers 350.

FIG. 9 is a top plan view of a portion of the end-effector 300 of FIG. 7 with a cover 362 (shown in FIG. 7) removed. The illustrated end-effector 300 further includes (a) an electrical driver 370 for moving the active retaining assembly 340 between the retracted and engagement positions, (b) an actuator 375 operably coupled to the electrical driver 370 and the active retaining assembly 340 for transmitting motion from the driver 370 to the assembly 340, and (c) a base 378 coupled to the body 310 for carrying the electrical driver 370. As such, the electrical driver 370 moves the actuator 375, which in turn drives the active retaining assembly 340. The electrical driver 370 can be a stepper motor, a DC motor, a piezoelectric motor, a linear motor, a solenoid, or another suitable device for moving the active retaining assembly 340 between the retracted and engagement positions. The actuator 375 can be a rotating or translating shaft or other suitable device for transmitting motion from the electrical driver 370 to the active retaining assembly 340. In the illustrated embodiment, for example, the actuator 375 includes a leadscrew and the yoke 342 includes a nut 348 with a threaded hole. The threads on the leadscrew engage the threads in the nut 348 so that rotation of the leadscrew moves the yoke 342 linearly in a direction parallel to the leadscrew. As such, the leadscrew drives the active retaining assembly 340 in the direction B or F depending upon the direction of rotation. In other embodiments, the actuator 375 can have a different configuration for transferring motion from the electrical driver 370 to the active retaining assembly 340. Moreover, in several embodiments, the base 378 can include one or more guides 365 and the yoke 342 can include corresponding channels 346 that slidably receive the guides 365 for restricting transverse movement of the active retaining assembly 340.

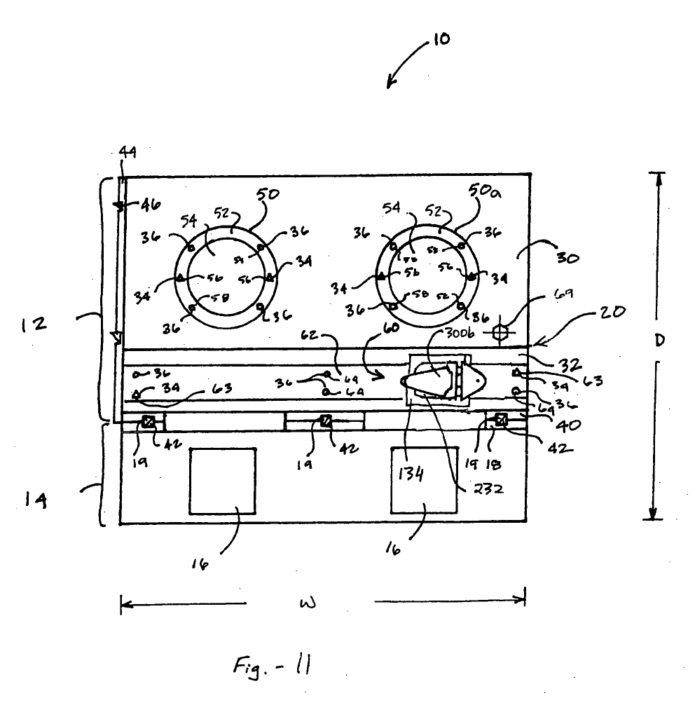

The illustrated end-effector 300 further includes a detector 380 for determining the position of the active retaining assembly 340 relative to the base 378. The illustrated detector 380 includes a shaft 382 coupled to the yoke 342 and first and second flag sensors 388 and 390 carried by the base 378. The shaft 382 includes a flag (shown in FIG. 10) and the first and second flag sensors 388 and 390 are positioned along a path of travel of the flag to detect the position of the flag. Based on the position of the flag, the detector 380 can determine the position of the active retaining assembly 340 as the assembly 340 moves between the retracted and engagement positions.

FIG. 10 is a schematic isometric view of the detector 380 in greater detail. In the illustrated embodiment, the flag 384 moves in a straight path P, and the first and second flag sensors 388 and 390 are horizontally spaced apart from one another. The first and second flag sensors 388 and 390 are configured to detect the presence or proximity of the flag 384 at a particular location in the travel path P. The first and second flag sensors 388 and 390 may detect the flag 384 in a variety of fashions. For example, the flag 384 may carry a magnet (not shown) and the first and second flag sensors 388 and 390 may be responsive to the proximity of the magnet in the flag 384.

In the illustrated embodiment, however, the first flag sensor 388 includes a first light source 388a and a first light sensor 388b, which are positioned on opposite sides of the travel path P of the flag 384. Similarly, the second flag sensor 390 includes a second light source 390a and a second light sensor 390b, which are positioned on opposite sides of the travel path P. The flag 384 is desirably opaque to wavelengths of light emitted by the first and second light sources 388a and 390a. When the opaque flag 384 is positioned between the first light source 388a and the first light sensor 388b, the flag 384 interrupts a beam of light 389 passing from the first light source 388a to the first light sensor 388b. This may generate a first flag position signal indicating that, for example, the active retaining assembly 340 (FIG. 9) is in the retracted position. Similarly, if the opaque flag 384 is positioned between the second light source 390a and the second light sensor 390b, the flag 384 will interrupt a beam of light 391 passing from the second light source 390a to the second light sensor 390b. This may generate a second flag position signal indicating that, for example, the active retaining assembly 340 is in the engagement position.

Referring back to FIG. 9, in other embodiments, the end-effector 300 may include other detectors for determining the position of the active retaining assembly 340. For example, the detector may be an encoder operably coupled to the electrical driver 370 to determine the position of the active retaining assembly 340 based on the output of the electrical driver 370. For example, in embodiments in which the electrical driver 370 is a stepper motor and the actuator 375 is a leadscrew, the encoder can determine the position of the active retaining assembly 340 based on the number of rotations of the leadscrew. In several embodiments, the end-effector 300 can determine the position of the active retaining assembly 340 with a timer based on a known speed of the retaining assembly 340. Alternatively, the end-effector 300 may not include a detector, but rather the electrical driver 370 may move the retaining assembly 340 to a hard stop.

The illustrated end-effector 300 further includes a workpiece pressure sensor 377 (shown schematically) coupled to the yoke 342 for determining the presence of a workpiece on the body 310. The workpiece pressure sensor 377 can include a switch, which is tripped when a workpiece is placed on the body 310. For example, the sensor 377 may include a spring-loaded plunger with a magnet and a member that is responsive to the proximity of the magnet. When a workpiece is loaded onto the body 310 and the active retaining assembly 340 moves to the engagement position, the workpiece contacts the plunger and moves the plunger from a first position to a second position. The member detects the change in the position of the magnet and, consequently, the presence of a workpiece on the body 310. In other embodiments, the workpiece pressure sensor can have other configurations and/or be positioned at different locations on the end-effector. In any of these embodiments, the pressure sensor can determine not only the presence of the workpiece but also if the workpiece is properly seated on the passive retaining elements 320.

One feature of the illustrated end-effector 300 is that the driver 370, the workpiece sensor 377, and the detector 380 are all electrically powered. As such, the end-effector 300 requires only rotary electrical couplings between the end-effector 300 and the arm 232 (FIG. 2), which reduces the number of required rotary couplings. In contrast, conventional end-effectors include rotary electrical couplings and rotary hydraulic and/or pneumatic couplings. Rotary hydraulic and pneumatic couplings are expensive and require extensive maintenance to prevent leaking and failure of the moving parts. Accordingly, the end-effector 300 illustrated in FIG. 7 (a) reduces maintenance expenses, (b) reduces the downtime to replace or repair components, and (c) increases throughput.

Another feature of the illustrated end-effector 300 is that the electrical driver 370 provides precise control over the movement of the active retaining assembly 340. An advantage of this feature is that the active retaining assembly 340 is expected to properly engage workpieces on a consistent basis without striking the workpieces with excessive force and damaging the workpieces. For example, in several embodiments, an encoder can slow the movement of the active retaining assembly just before the assembly contacts the workpiece so that the assembly engages the workpiece without excessive force. Moreover, the encoder can be coupled to the pressure sensor to determine whether a workpiece is properly seated on the body 310. For example, after the encoder has moved the active retaining assembly to the engagement position, if the pressure sensor has not sensed the presence of the workpiece, the encoder may generate a signal indicating that the workpiece is not properly seated on the end-effector.

D. Embodiments of Modular Tool Units Including Transfer Devices

FIG. 11 illustrates another environment in which the transfer devices described above can be used. FIG. 11 is a top plan view of a modular tool unit 10 including a processing module 12 and a load/unload module 14. The processing module 12 includes a mounting module 20, wet chemical processing chambers 50 attached to one portion of the mounting module 20, and a transport system 60 attached to another portion of the mounting module 20. The load/unload module 14 includes workpiece holders 16 for holding workpieces before and after being processed in the processing chambers 50.

The mounting module 20 is a rigid, stable structure that maintains the relative positions between the wet chemical processing chambers 50 and the transport system 60. One aspect of the mounting module 20 is that it defines a fixed reference frame because it is much more rigid and has significantly greater structural integrity than conventional processing platforms for holding wet chemical processing chambers. Another aspect of the mounting module 20 is that it includes positioning elements that engage corresponding chamber interface members to position the processing chambers 50 at precise locations in the fixed reference frame of the mounting module 20. The mounting module 20 accordingly provides a system in which wet chemical processing chambers, transport systems, load/unload modules, and other modular tool units can be assembled in a manner that accurately positions the components at precise locations so that the transport system 60 can be easily calibrated to work with the various components.

The mounting module 20 illustrated in FIG. 11 includes a dimensionally stable deck 30 and a dimensionally stable platform 32. As explained in more detail below, the deck 30 can be made from a plurality of panels and bracing that form a strong, rigid structure which maintains precise dimensions. The mounting module 20 further includes a plurality of positioning elements 34 at precise predetermined locations in the fixed reference frame of the mounting module 20 and a plurality of attachment elements 36. In general, the mounting module 20 has two or more positioning elements 34 and two or more attachment elements 36 at each processing site on the deck 30. The mounting module 20 also has positioning elements 34 and attachment elements 36 at the platform 32 that interface with the transport system 60. The positioning elements 34 can be pins or holes that mate with a corresponding structure of a chamber or transport system 60. The attachment elements 36 can be threaded studs or threaded holes to engage a corresponding structure of the processing chambers and the transport system 60.

The mounting module 20 can further include a front docking unit 40 at the front side of the platform 32. The front docking unit 40 can include a plurality of front alignment elements 42 at predetermined locations in the fixed reference frame of the mounting module 20. The docking unit 40 can be a panel of 0.25 inch stainless steel fixedly attached to the platform 32 to remain dimensionally stable in the fixed reference frame of the mounting module 20. The load/unload unit 14 can further include a first docking unit 18 having first alignment elements 19. The first docking unit 18 can be a 0.25 inch panel of stainless steel, and the first alignment elements 19 are configured to engage the front alignment elements 42 of the front docking unit 40 to accurately align the workpiece holders 16 with the fixed reference frame of the mounting module 20.

The mounting module 20 can optionally include a side docking unit 44 having a plurality of side alignment elements 46 for connecting a second modular mounting tool unit (not shown in FIG. 11) to the modular tool unit 10. The side docking unit 44 can be a 0.25 inch panel of stainless steel fixedly attached to the deck 30 and the platform 32 so that the side alignment elements 46 are at predetermined locations in the fixed reference frame of the mounting module 20.

The wet chemical processing chambers 50 in the embodiment illustrated in FIG. 11 include a flange 52 and a vessel 54 attached to the flange 52. The flange 52 is a dimensionally stable component that includes chamber interface members 56 at predetermined locations relative to the vessel 54 and chamber fasteners 58. The chamber interface members 56 are arranged in a pattern to mate with corresponding positioning elements 34 at a processing station on the deck 30. The fit between the positioning element 34 and the chamber interface members 56 is very tight so that the vessel 54 is positioned precisely at a predetermined location with respect to the fixed reference frame of the mounting module 20 when the chamber interface members 56 are engaged with corresponding positioning elements 34 on the deck 30.

The wet chemical processing chambers 50 can be electrochemical deposition chambers, spin-rinse-dry chambers, cleaning capsules, etching chambers, or other suitable wet chemical processing stations. In the case of electrochemical deposition chambers, the processing chamber 50 has an electrical system including a first electrode configured to contact the workpiece and a second electrode disposed in the vessel 54. The first and second electrodes establish an electrical field to plate ions in an electrolytic solution onto the workpiece. It will be appreciated that the electrochemical processing chamber 50 can be an electroless chamber that does not include an electrical system with first and second electrodes. Suitable electrochemical deposition chambers are disclosed in (a) U.S. Pat. Nos. 6,569,297 and 6,660,137; and (b) U.S. Publication Nos. 2003/0068837; 2003/0079989; 2003/0057093; 2003/0070918; 2002/0032499; 2002/0139678; 2002/0125141; 2001/0032788; 2003/0127337; and 2004/0013808, all of which are herein incorporated by reference in their entirety. In other embodiments, the wet chemical processing chambers can be capsules or other types of chambers for cleaning wafers, such as those shown in U.S. Pat. Nos. 6,350,319; 6,423,642; and 6,413,436, all of which are herein incorporated by reference in their entirety.

The modular tool unit 10 can alternatively include various combinations of wet chemical processing chambers. For example, all of the chambers can be a common type (e.g., electrochemical deposition chambers, cleaning chambers, etching chambers, etc.), or various combinations of different types of chambers can be mounted to the deck 30 of the modular tool unit 10. Suitable combinations of wet chemical processing chambers are disclosed in the references incorporated above.

The transport system 60 includes a track 62 with a plurality of track interface members 63 and track fasteners 64. The track interface members 63 are arranged to engage corresponding positioning elements 34 on the platform 32 to position the track 62 at a known location in the fixed reference frame of the mounting module 20. The track 62 extends laterally along a width-wise direction W relative to the front of the modular tool unit 10 as opposed to extending axially along a depth-wise direction D of the mounting module 20. The transport system 60 can further include the robot 134 with the first end-effector 300a (not shown in FIG. 11) and the second end-effector 300b. The robot 134 moves linearly along the track 62 to move laterally between the workpiece holders 16 and/or the processing chambers 50. Suitable tracks are disclosed in U.S. Pat. Nos. 6,752,584 and 6,749,390, and U.S. Publication No. 2003/0159921, all of which are herein incorporated by reference in their entirety.

The transport system 60 includes a track 62 with a plurality of track interface members 63 and track fasteners 64. The track interface members 63 are arranged to engage corresponding positioning elements 34 on the platform 32 to position the track 62 at a known location in the fixed reference frame of the mounting module 20. The track 62 extends laterally along a width-wise direction W relative to the front of the modular tool unit 10 as opposed to extending axially along a depth-wise direction D of the mounting module 20. The transport system 60 can further include the robot 134 with the first end-effector 300a (not shown in FIG. 11) and the second end-effector 300b. The robot 134 moves linearly along the track 62 to move laterally between the workpiece holders 16 and/or the processing chambers 50. Suitable tracks are disclosed in U.S. Pat. Nos. 6,752,584 and 6,749,390, and U.S. Publication No. 2003/0159921, all of which are herein incorporated by reference in their entirety.

The transport system 60 can further include a calibration unit 69 attached to the deck 30 as shown in FIG. 11 or the platform 32 (not shown). The calibration unit 69 is fixed at a known location in the reference frame of the mounting module 20. The calibration unit 69 automatically determines the position of the robot 134 and the end-effectors 300 relative to the fixed reference frame of the mounting module 20 and corrects any misalignment of the robot 134 and end-effectors 300 so that the transport system 60 can accurately interface with the workpiece holders 16 and the processing chambers 50 without having to manually teach the robot 134 the location of each of the components in the modular tool unit 10. Suitable calibration units and calibration methods for use with the modular tool unit 10 are disclosed in U.S. patent application Ser. Nos. 10/860,385 and 10/861,240, which are herein incorporated by reference in their entirety.

The embodiment of the modular tool unit 10 illustrated in FIG. 11 with the robot 134 provides several advantages for tool manufacturers and microdevice manufacturers. One feature of the illustrated robot 134 is that the arm 232 carrying the coaxial end-effectors 300 projects in a single direction. Because the arm 232 projects in a single direction, the robot 134 can rotate in less space than a robot having two arm sections projecting away from each other in diametrically opposing directions. As such, the spacing between the workpiece holders 16 and the processing chambers 50 across the track 62 can be reduced without the risk that the arm 232 may contact one of the workpiece holders 16 or processing chambers 50 as the arm 232 rotates during operation. An advantage of this feature is that the footprint of the tool unit 10 in the depth-wise direction D can be reduced.

Another feature of the illustrated robot 134 is that the coaxial end-effectors 300 can perform certain tasks without moving the robot 134 along the track 62. For example, the first end-effector 300a (not shown in FIG. 11) can pick up a first workpiece from a processing chamber 50a and the second end-effector 300b can place a second workpiece at the first processing chamber 50a without moving the robot 134 linearly along the track 62. This feature advantageous reduces the time required to perform certain tasks, which increases the throughput of the tool unit 10.

From the foregoing, it will be appreciated that specific embodiments of the invention have been described herein for purposes of illustration, but that various modifications may be made without deviating from the spirit and scope of the invention. For example, although specific configurations of end-effectors have been described above with reference to FIGS. 7-10, the transfer devices described above with reference to FIGS. 1-6 may include end-effectors with other configurations. Moreover, the transfer devices described above can be used in environments other than those described above with reference to FIG. 11. Accordingly, the invention is not limited except as by the appended claims.

I/We claim:

1. A transfer device for handling microfeature workpieces within an environment of a processing machine, the transfer device comprising:
a base unit;
an arm assembly carried by the base unit and movable along a lift path, the arm assembly including an arm and an arm actuator coupled to the arm for pivoting the arm about the lift path;
a first end-effector rotatably coupled to the arm without a rotary pneumatic coupling, the first end-effector being rotatable about an axis generally parallel to the lift path; and
a second end-effector rotatably coupled to the arm without a rotary pneumatic coupling, the second end-effector being coaxially rotatable about the axis.

2. The transfer device of claim 1, further comprising:
a first drive assembly for rotating the first end-effector about the axis, the first drive assembly including a first motor, a first pulley operably coupled to the first end-effector, a first belt for transmitting motion from the first motor to the first pulley, and a first quick-release mechanism for removing the first belt from the first pulley without detaching the first pulley; and
a second drive assembly for rotating the second end-effector about the axis, the second drive assembly including a second motor, a second pulley operably coupled to the second end-effector, a second belt for transmitting motion from the second motor to the second pulley, and a second quick-release mechanism for removing the second belt from the second pulley without detaching the second pulley.

3. The transfer device of claim 2 wherein:
the first pulley includes a first groove;
the first quick-release mechanism comprises a first flange adjacent to the first pulley and a first snap ring adjacent to the first flange, the first flange having a first portion projecting beyond the first pulley to inhibit the first belt from sliding off the first pulley in a direction generally parallel to the axis, the first snap ring being movable between (a) a first position in which the first ring is partially received in the first groove and holds the first flange against the first pulley so that the first portion inhibits the first belt from sliding off the first pulley, and (b) a second position in which the first ring is positioned outside the first groove so that the first ring, the first flange, and the first belt can slide off the first pulley;
the second pulley includes a second groove; and
the second quick-release mechanism comprises a second flange adjacent to the second pulley and a second snap ring adjacent to the second flange, the second flange having a second portion projecting beyond the second pulley to inhibit the second belt from sliding off the second pulley in a direction generally parallel to the axis, the second snap ring being movable between (a) a first position in which the second ring is partially received in the second groove and holds the second flange against the second pulley so that the second portion inhibits the second belt from sliding off the second pulley, and (b) a second position in which the second ring is positioned outside the second groove so that the second ring, the second flange, and the second belt can slide off the second pulley.

4. The transfer device of claim 1, further comprising:
a first drive assembly for rotating the first end-effector about the axis, the first drive assembly including a first motor, a first pulley operably coupled to the first end-effector, and a first belt for transmitting motion from the first motor to the first pulley, wherein the first motor is movable relative to the first pulley in a first direction transverse to the axis for adjusting a tension in the first belt; and
a second drive assembly for rotating the second end-effector about the axis, the second drive assembly including a second motor, a second pulley operably coupled to the second end-effector, and a second belt for transmitting motion from the second motor to the second pulley, wherein the second motor is movable relative to the second pulley in a second direction transverse to the axis for adjusting a tension in the second belt.

5. The transfer device of claim 1, further comprising:
a first drive assembly for rotating the first end-effector about the axis, the first drive assembly including a first motor, a first mounting member coupling the first motor to the arm assembly, a first pulley operably coupled to the first end-effector, a first belt for transmitting motion from the first motor to the first pulley, and a first tensioning mechanism for adjusting a tension in the first belt by selectively moving the first mounting member relative to the first pulley; and
a second drive assembly for rotating the second end-effector about the axis, the second drive assembly including a second motor, a second mounting member coupling the second motor to the arm assembly, a second pulley operably coupled to the second end-effector, a second belt for transmitting motion from the second motor to the second pulley, and a second tensioning mechanism for adjusting a tension in the second belt by selectively moving the second mounting member relative to the second pulley.

6. The transfer device of claim 5 wherein:
the arm includes a housing with a wall;
the first tensioning mechanism comprises a first adjustment bolt extending through the wall of the housing and threadably engaging the first mounting member so that rotation of the first adjustment bolt moves the first mounting member relative to the arm; and
the second tensioning mechanism comprises a second adjustment bolt extending through the wall of the housing and threadably engaging the second mounting member so that rotation of the second adjustment bolt moves the second mounting member relative to the arm.

7. The transfer device of claim 1 wherein the transfer device operates normally without pneumatic power.

8. The transfer device of claim 1 wherein the first end-effector comprises:
a body;
a plurality of spaced-apart, stationary retaining elements carried by the body, the stationary retaining elements configured to support the workpiece in a plane spaced apart from the body;
an active retaining assembly movable relative to the body, the active retaining assembly including a yoke with a first portion and a second portion opposite the first portion, the active retaining assembly further including a first roller coupled to the first portion and a second roller coupled to the second portion;
an actuator operably coupled to the active retaining assembly for moving the assembly between a retracted position to load/unload a workpiece and an engagement position to hold the workpiece; and
an electrical motor for driving the actuator to move the active retaining assembly.

9. The transfer device of claim 8 wherein:
the actuator comprises a leadscrew operably coupled to the electrical motor and the active retaining assembly;
the electrical motor is configured to rotate the leadscrew; and
the active retaining assembly further comprises a threaded hole sized and configured to receive a portion of the leadscrew so that rotation of the leadscrew moves the retaining assembly linearly.

10. The transfer device of claim 1 wherein the first end-effector comprises:
a body comprising a carbon-fiber and vespel material;
a passive retaining element carried by the body;
an active retaining assembly movable relative to the body, the passive retaining element and the active retaining assembly configured to selectively grasp the workpiece; and
a driver operably coupled to the active retaining assembly for moving the assembly between a retracted position and an engagement position.

11. The transfer device of claim 1, further comprising a transport unit configured to move along a linear track, the transport unit including the base unit.

12. A transfer device for handling microfeature workpieces within an environment of a processing machine, the transfer device comprising:
a transport unit;
an arm assembly carried by the transport unit, the arm assembly including an arm pivotable about a first axis and a rotary electrical connection;
a first end-effector rotatably coupled directly to the arm and rotatable about a second axis generally parallel to the first axis, the first end-effector having a rotary electrical connection electrically coupled to the rotary electrical connection of the arm; and
a second end-effector rotatably coupled to the arm and coaxially rotatable about the second axis.

13. The transfer device of claim 12 wherein the device operates normally without pneumatic power.

14. The transfer device of claim 12 wherein the first end-effector is coupled to the arm without an intervening link rotatably connected between the arm and the first end-effector.

15. The transfer device of claim 12, further comprising:
a first drive assembly for rotating the first end-effector about the second axis, the first drive assembly including a first motor, a first pulley operably coupled to the first end-effector, a first belt for transmitting motion from the first motor to the first pulley, and a first quick-release mechanism for removing the first belt from the first pulley without detaching the first pulley; and
a second drive assembly for rotating the second end-effector about the second axis, the second drive assembly including a second motor, a second pulley operably coupled to the second end-effector, a second belt for transmitting motion from the second motor to the second pulley, and a second quick-release mechanism for removing the second belt from the second pulley without detaching the second pulley.

16. The transfer device of claim 12, further comprising:
a first drive assembly for rotating the first end-effector about the second axis, the first drive assembly including a first motor, a first mounting member coupling the first motor to the arm assembly, a first pulley operably coupled to the first end-effector, a first belt for transmitting motion from the first motor to the first pulley, and a first tensioning mechanism for adjusting a tension in the first belt by selectively moving the first mounting member relative to the first pulley; and
a second drive assembly for rotating the second end-effector about the second axis, the second drive assembly including a second motor, a second mounting member coupling the second motor to the arm assembly, a second pulley operably coupled to the second end-effector, a second belt for transmitting motion from the second motor to the second pulley, and a second tensioning mechanism for adjusting a tension in the second belt by selectively moving the second mounting member relative to the second pulley.

17. The transfer device of claim 12 wherein the first end-effector comprises:
a body;
a plurality of spaced-apart, stationary retaining elements carried by the body, the stationary retaining elements configured to support the workpiece in a plane spaced apart from the body;
an active retaining assembly movable relative to the body, the active retaining assembly including a yoke with a first portion and a second portion opposite the first portion, the active retaining assembly further including a first roller coupled to the first portion and a second roller coupled to the second portion;
an actuator operably coupled to the active retaining assembly for moving the assembly between a retracted position to load/unload a workpiece and an engagement position to hold the workpiece; and
an electrical motor for driving the actuator to move the active retaining assembly.

18. The transfer device of claim 17 wherein:
the actuator comprises a leadscrew operably coupled to the electrical motor and the active retaining assembly;
the electrical motor is configured to rotate the leadscrew; and
the active retaining assembly further comprises a threaded hole sized and configured to receive a portion of the leadscrew so that rotation of the leadscrew moves the retaining assembly linearly.

19. The transfer device of claim 12 wherein the first end-effector comprises:
a body comprising a carbon-fiber and vespel material;
a passive retaining element carried by the body;
an active retaining assembly movable relative to the body, the passive retaining element and the active retaining assembly configured to selectively grasp the workpiece; and
a driver operably coupled to the active retaining assembly for moving the assembly between a retracted position and an engagement position.

20. A transfer device for handling microfeature workpieces within an environment of a processing machine, the transfer device comprising:
a transport unit;
an arm assembly carried by the transport unit, the arm assembly including an arm pivotable about a first axis;
a first end-effector coupled to the arm and rotatable about a second axis generally parallel to the first axis, wherein the first end-effector can freely rotate over 360 degrees; and
a second end-effector coupled to the arm and rotatable about the second axis, wherein the second end-effector can freely rotate over 360 degrees.

21. A transfer device for handling microfeature workpieces within an environment of a processing machine, the transfer device comprising:
a transport unit;
an arm assembly carried by the transport unit, the arm assembly including an arm pivotable about a first axis;
a first end-effector coupled to the arm and rotatable about a second axis generally parallel to the first axis;
a first drive assembly for rotating the first end-effector about the second axis, the first drive assembly including a first motor, a first pulley operably coupled to the first end-effector, a first belt for transmitting motion from the first motor to the first pulley, and a first quick-release mechanism for removing the first belt from the first pulley;
a second end-effector coupled to the arm and rotatable about the second axis; and
a second drive assembly for rotating the second end-effector about the second axis, the second drive assembly including a second motor, a second pulley operably coupled to the second end-effector, a second belt for transmitting motion from the second motor to the second pulley, and a second quick-release mechanism for removing the second belt from the second pulley.

22. The transfer device of claim 21 wherein:
the first pulley includes a first groove;
the first quick-release mechanism comprises a first flange adjacent to the first pulley and a first snap ring adjacent to the first flange, the first flange having a first portion projecting beyond the first pulley to inhibit the first belt from sliding off the first pulley in a direction generally parallel to the second axis, the first snap ring being movable between (a) a first position in which the first ring is partially received in the first groove and holds the first flange against the first pulley so that the first portion inhibits the first belt from sliding off the first pulley, and (b) a second position in which the first ring is positioned outside the first groove so that the first ring, the first flange, and the first belt can slide off the first pulley;
the second pulley includes a second groove; and
the second quick-release mechanism comprises a second flange adjacent to the second pulley and a second snap ring adjacent to the second flange, the second flange having a second portion projecting beyond the second pulley to inhibit the second belt from sliding off the second pulley in a direction generally parallel to the second axis, the second snap ring being movable between (a) a first position in which the second ring is partially received in the second groove and holds the second flange against the second pulley so that the second portion inhibits the second belt from sliding off the second pulley, and (b) a second position in which the second ring is positioned outside the second groove so that the second ring, the second flange, and the second belt can slide off the second pulley.

23. The transfer device of claim 21 wherein:
the first quick-release mechanism is configured so that an operator can remove the first belt from the first pulley without detaching the first pulley; and
the second quick-release mechanism is configured so that the operator can remove the second belt from the second pulley without detaching the second pulley.

24. The transfer device of claim 21 wherein:
the first drive assembly further comprises a first mounting member coupling the first motor to the arm assembly and a first tensioning mechanism for adjusting a tension in the first belt by selectively moving the first mounting member relative to the first pulley; and
the second drive assembly further comprises a second mounting member coupling the second motor to the arm assembly and a second tensioning mechanism for adjusting a tension in the second belt by selectively moving the second mounting member relative to the second pulley.

25. The transfer device of claim 21 wherein the transfer device operates normally without pneumatic power.

26. The transfer device of claim 21 wherein:
the first end-effector is rotatably coupled to the arm without a rotary pneumatic coupling; and
the second end-effector is rotatably coupled to the arm without a rotary pneumatic coupling.

27. The transfer device of claim 21 wherein the first end-effector comprises:
a body;
a plurality of spaced-apart, stationary retaining elements carried by the body, the stationary retaining elements configured to support the workpiece in a plane spaced apart from the body;
an active retaining assembly movable relative to the body, the active retaining assembly including a yoke with a first portion and a second portion opposite the first portion, the active retaining assembly further including a first roller coupled to the first portion and a second roller coupled to the second portion;
an actuator operably coupled to the active retaining assembly for moving the assembly between a retracted position to load/unload a workpiece and an engagement position to hold the workpiece; and
an electrical motor for driving the actuator to move the active retaining assembly.

28. A transfer device for handling microfeature workpieces within an environment of a processing machine, the transfer device comprising:
a transport unit;
an arm assembly carried by the transport unit, the arm assembly including an arm pivotable about a first axis;
a first end-effector coupled to the arm and rotatable about a second axis generally parallel to the first axis;
a first drive assembly for rotating the first end-effector about the second axis, the first drive assembly including a first motor, a first mounting member coupling the first motor to the arm assembly, a first pulley operably coupled to the first end-effector, a first belt for transmitting motion from the first motor to the first pulley, and a first tensioning mechanism for adjusting a tension in the first belt by selectively moving the first mounting member relative to the first pulley;
a second end-effector coupled to the arm and rotatable about the second axis; and
a second drive assembly for rotating the second end-effector about the second axis, the second drive assembly including a second motor, a second mounting member coupling the second motor to the arm assembly, a second pulley operably coupled to the second end-effector, a second belt for transmitting motion from the second motor to the second pulley, and a second tensioning mechanism for adjusting a tension in the second belt by selectively moving the second mounting member relative to the second pulley.

29. The transfer device of claim 28 wherein:
the first drive assembly further comprises a first quick-release mechanism for removing the first belt from the first pulley without detaching the first pulley; and
the second drive assembly further comprises a second quick-release mechanism for removing the second belt from the second pulley without detaching the second pulley.

30. The transfer device of claim 28 wherein:
the arm includes a housing with a wall;
the first tensioning mechanism comprises a first adjustment bolt extending through the wall of the housing and threadably engaging the first mounting member so that rotation of the first adjustment bolt moves the first mounting member relative to the arm; and
the second tensioning mechanism comprises a second adjustment bolt extending through the wall of the housing and threadably engaging the second mounting member so that rotation of the second adjustment bolt moves the second mounting member relative to the arm.

31. The transfer device of claim 28 wherein the transfer device operates normally without pneumatic power.

32. The transfer device of claim 28 wherein the first end-effector comprises:
a body;
a plurality of spaced-apart, stationary retaining elements carried by the body, the stationary retaining elements configured to support the workpiece in a plane spaced apart from the body;
an active retaining assembly movable relative to the body, the active retaining assembly including a yoke with a first portion and a second portion opposite the first portion, the active retaining assembly further including a first roller coupled to the first portion and a second roller coupled to the second portion;
an actuator operably coupled to the active retaining assembly for moving the assembly between a retracted position to load/unload a workpiece and an engagement position to hold the workpiece; and
an electrical motor for driving the actuator to move the active retaining assembly.

33. The transfer device of claim 28 wherein:
the first end-effector is rotatably coupled to the arm without a rotary pneumatic coupling; and
the second end-effector is rotatably coupled to the arm without a rotary pneumatic coupling.

34. A transfer device for handling microfeature workpieces within an environment of a processing machine, the transfer device comprising:
a transport unit;
an arm assembly carried by the transport unit, the arm assembly including an arm pivotable about a first axis;
a first end-effector coupled to the arm and rotatable about a second axis generally parallel to the first axis, the first end-effector comprising a first body, a first plurality of passive retaining elements carried by the first body, a first active retaining assembly movable relative to the first body, and a first electrical driver operably coupled to the first active retaining assembly for moving the first assembly between a retracted position and an engagement position, the first passive retaining elements defining a first workpiece-receiving area, the first active retaining assembly including a first roller for engaging a perimeter edge of the first workpiece; and
a second end-effector coupled to the arm and rotatable about the second axis, the second end-effector comprising a second body, a second plurality of passive retaining elements carried by the second body, a second active retaining assembly movable relative to the second body, and a second electrical driver operably coupled to the second active retaining assembly for moving the second assembly between a retracted position and an engagement position, the second passive retaining elements defining a second workpiece-receiving area, the second active retaining assembly including a second roller for engaging a perimeter edge of the second workpiece.

35. The transfer device of claim 34, further comprising:
a first drive assembly for rotating the first end-effector about the second axis, the first drive assembly including a first motor, a first pulley operably coupled to the first end-effector, a first belt for transmitting motion from the first motor to the first pulley, and a first quick-release mechanism for removing the first belt from the first pulley without detaching the first pulley; and
a second drive assembly for rotating the second end-effector about the second axis, the second drive assembly including a second motor, a second pulley operably coupled to the second end-effector, a second belt for transmitting motion from the second motor to the second pulley, and a second quick-release mechanism for removing the second belt from the second pulley without detaching the second pulley.

36. The transfer device of claim 34, further comprising:
a first drive assembly for rotating the first end-effector about the second axis, the first drive assembly including a first motor, a first mounting member coupling the first motor to the arm assembly, a first pulley operably coupled to the first end-effector, a first belt for transmitting motion from the first motor to the first pulley, and a first tensioning mechanism for adjusting a tension in the first belt by selectively moving the first mounting member relative to the first pulley; and
a second drive assembly for rotating the second end-effector about the second axis, the second drive assembly including a second motor, a second mounting member coupling the second motor to the arm assembly, a second pulley operably coupled to the second end-effector, a second belt for transmitting motion from the second motor to the second pulley, and a second tensioning mechanism for adjusting a tension in the second belt by selectively moving the second mounting member relative to the second pulley.

37. The transfer device of claim 34 wherein the transfer device operates normally without pneumatic power.

38. The transfer device of claim 34 wherein:
the first end-effector is rotatably coupled to the arm without a rotary pneumatic coupling; and
the second end-effector is rotatably coupled to the arm without a rotary pneumatic coupling.

39. A method for processing microfeature workpieces in a processing apparatus, the method comprising:
holding a workpiece with a transfer device having a base unit and first and second end-effectors rotatably coupled to the base unit;
pivoting the first end-effector about an axis without a rotary pneumatic coupling between the first end-effector and the base unit; and
rotating the second end-effector about the axis without a rotary pneumatic coupling between the second end-effector and the base unit.

40. The method of claim 39 wherein:
the transfer device further comprises an arm coupled to the transport unit and carrying the first and second end-effectors, the arm including a motor, a pulley coupled to the first end-effector, and a belt for transmitting motion from the motor to the pulley; and
the method further comprises removing the belt from the pulley without detaching the pulley from the arm.

41. The method of claim 39 wherein:
the transfer device further comprises an arm coupled to the transport unit and carrying the first and second end-effectors, the arm including a motor, a pulley coupled to the first end-effector, and a belt for transmitting motion from the motor to the pulley; and
the method further comprises removing the belt from the pulley with a quick-release mechanism.

42. The method of claim 39 wherein:
the transfer device further comprises an arm coupled to the transport unit and carrying the first and second end-effectors, the arm including a motor, a mounting member attached to the motor, a pulley coupled to the first end-effector, and a belt for transmitting motion from the motor to the pulley; and
the method further comprising adjusting a tension in the belt by moving the mounting member relative to the pulley.

43. The method of claim 39, further comprising energizing an electrical driver on the first end-effector to move an active retaining assembly from a retracted position to an engagement position for holding a workpiece.

44. The method of claim 39, further comprising providing electrical power to a stepper motor on the first end-effector for driving an active retaining assembly from a retracted position to a engagement position.

45. The method of claim 39, further comprising moving the base unit along a linear track.

46. The method of claim 39 wherein:
pivoting the first end-effector about the axis comprises rotating the first end-effector over 360 degrees; and
rotating the second end-effector about the axis comprises pivoting the second end-effector over 360 degrees.

47. A method for processing microfeature workpieces in a processing apparatus, the method comprising:
pivoting first and second end-effectors of a transfer device about a common axis using an electromotive force to actuate rotation of the first and second end-effectors; and
grasping a microfeature workpiece with the first and/or second end-effector.

48. The method of claim 47, further comprising moving the transfer device along a linear track.

49. The method of claim 47 wherein grasping the workpiece comprises holding the workpiece without pneumatic power.

50. The method of claim 47 wherein grasping the workpiece comprises grasping the workpiece with the electromotive force.

51. The method of claim 47 wherein:
pivoting the end-effectors comprises rotating the end-effectors without pneumatic power; and
grasping the workpiece comprises holding the workpiece without pneumatic power.
